(19) United States
(12) Patent Application Publication
(10) Pub. No.: US 2021/0356848 A1
(43) Pub. Date: Nov. 18, 2021

(54) Projection module and projector

(71) Applicant: NANHUA INTELLIGENT PRECISION MACHINE (SHENZHEN) CO.,LTD., Shenzhen (CN)

(72) Inventor: Hanwen Guo, Shenzhen (CN)

(73) Assignee: NANHUA INTELLIGENT PRECISION MACHNE (SHENZHEN) CO.,LTD

(21) Appl. No.: 17/387,746

(22) Filed: Jul. 28, 2021

(30) Foreign Application Priority Data
Jun. 21, 2021 (CN) 202110688957.X

(51) Int. Cl. G03B 21/00; G03B 33/12

(52) U.S. Cl. CPC G03B 21/006; G03B 33/12

(57) ABSTRACT

A projection module includes two or three transmissive liquid crystal display (LCD) light valves, a light combining device and a projection lens. When there are three LCD light valves, the light combining device is an X-cube, a long side of a display window of any one of the LCD light valves is parallel to a central intersection line of the X-cube. When there are a first LCD light valve and a second LCD light valve, light emitted by the first LCD light valve passes through the light combining device and the projection lens in sequence and then is projected out; light emitted by the second LCD light valve is reflected by the light combining device and overlaps with light transmitted by the first LCD light valve through the light combining device, and then is projected out through the projection lens. A projector includes the projection module.

### CROSS REFERENCE OF RELATED APPLICATION

The present invention claims priority under 35 U.S.C. 119(a-d) to CN 202110688957.X, filed Jun. 21, 2021.

### BACKGROUND OF THE PRESENT INVENTION

### Field of Invention

The present invention relates to the field of projectors, and more particularly to a projection module and an LCD (liquid crystal display) projector.

### Description of Related Arts

FIGS. 5-8 show a traditional 3LCD (liquid crystal display) projector, in which three LCD light valves and a light combining device are arranged in a manner that a short side H′ of a display window of any one of the three LCD light valves is parallel to a central intersection line A′ of an X-cube 2′. In FIGS. 5-8, a projection lens 1′, an X-cube 2′, a first LCD light valve for displaying red field images 3′, a second LCD light valve for displaying green field images 4′, a third LCD light valve for displaying blue field images 5′, and flexible printed circuits (FPCs) cables 10 of the first, second and third LCD light valves are illustrated, wherein “//” is a parallel symbol. This arrangement is destined by the development direction and historical accumulation of foreign 3LCD projection technology. In the past 30 years, LCD light valves based on high temperature poly-silicon (HTPS) technology have become smaller and smaller, from about 1.3 inches in early mass production to about 0.5 inches now. Correspondingly, the volume of the X-cube 2′ is getting smaller and smaller, and the cost is getting lower and lower.

In recent years, the core component of 3LCD projectors is the LCD light valve. Domestic mass production is able to be achieved through low temperature poly-silicon (LTPS) technology. However, the size of domestic LCD light valves is still too large at this stage. At present, only LCD light valves with about 2-2.5 inches are able to be stably manufactured through LTPS technology. Compared with light valves based on foreign HTPS technology, under the same resolution, the size of domestic light valves based on LTPS technology is 4-5 times larger, but the advantage is that the cost is reduced by 3-5 times; and at the same time, light valves are large in size, so that when the projector outputs the same brightness, the light valves are able to dissipate heat relatively easily. Moreover, due to the large size of the light valves, the smaller the limit on the optical extension of the projection light source, the projector is able to output higher brightness. Therefore, if the X-cube 2′ suitable for domestically-made larger LCD light valves is designed and manufactured according to the traditional arrangement of the LCD light valves and the light combining device shown in FIG. 5, that is, the short side H′ of the display window of any one LCD light valve is parallel to the central intersection line A′ of the X-cube 2′, which will cause that the production difficulty and production cost of the X-cube 2′ are very high, so that the competitiveness of the projector is extremely adversely affected.

FIG. 6 is a structurally schematic view of the X-cube 2′, which comprises four right-angle prisms bonded with each other, wherein an optical film with complex principle is manufactured on every bonding surface for combining light on three LCD light valves, right angle vertices of the four right-angle prisms coincide and form a straight line, that is, the central intersection line A′ of the X-cube 2′.

Before the X-cube was invented, the three LCD light valves of the 3LCD projector synthesize light through multiple dichroic plates, or a combination of multiple dichroic plates, multiple right-angle prisms and multiple glass light guide rods. This technology causes the projection lens to have an extremely long back focal length, and that the limitation on the optical extension of the projection light source is very limited. Therefore, it has been completely eliminated at the end of the last century.

As shown in FIGS. 9-10, due to the relatively complicated manufacturing process and high cost of 3LCD projectors, while achieving breakthroughs in domestic LCD light valve technology, a more compact and high optical efficiency 2LCD projector was also born, referring to the US authorized patents U.S. Pat. No. 10,809,610 B1 and U.S. Pat. No. 10,859,900 B1. In the existing 2LCD projectors, there are also engineering problems similar to those of the above-mentioned light combining device of 3LCD projector (which is described later). In FIG. 9, the light combining device 21′, which is achieved by the prism such as polarization beam splitter (PBS) prism or dichroic prism, comprises two right-angle prisms with the same size and two spectroscopic optical films 210′ coated on two inclined planes of the two right-angle prisms, respectively, wherein the inclined planes of the two right-angle prisms are bonded with each other. Referring to FIG. 9, two LCD light valves 6′ and 7′, a length a″ of a display window of any one of the two LCD light valves, the arrangement of the two LCD light valves 6′ and 7′ and the spectroscopic optical films 210′ are illustrated. The relative arrangement relationship of the length a″ and the spectroscopic optical membranes 210′ is an important identification parameter for distinguishing the technology of the present invention from the prior art.

FIG. 10 shows the existing 2LCD projection technology in which the light combining device is embodied as a flat light combining lens 8′. The flat light combining lens 8′ generally uses wavelength or polarization as a spectroscopic method. A dichroic film is formed on an exit surface of the flat light combining lens 8′. Referring to FIG. 10, the arrangement of the two LCD light valves 6′ and 7′ and the flat light combining lens 8′ is illustrated, in which a″ represents the long side of the display window of any one of the LCD light valves 6′ and 7′.

The purpose of the present invention is to overcome the light combining problem caused by the large size of domestic LCD light valves, so that the production of the X-cube of the 3LCD projector or the light combining device of the 2LCD projector becomes simple and cheap, and at the same time, the present invention is also positively helpful for reducing the volume of the whole machine, changing the shape and stacking of the whole machine, and reducing the production cost of the projection lens.

### SUMMARY OF THE PRESENT INVENTION

In order to solve the above technical problems, an object of the present invention is to provide a projection module, which is able to significantly improve the manufacturing difficulty of the X-cube of 3LCD projectors with larger light valves or the light combining device of 2LCD projectors, achieve relative cheap production cost, reduce the volume of the whole machine, change the shape and stacking of the whole machine, and reduce the production cost of the projection lens.

Accordingly, the present invention provides a projection module, which comprises two or three transmissive liquid crystal display (LCD) light valves, a light combining device and a projection lens, wherein:

when there are three transmissive LCD light valves, the light combining device is an X-cube, a long side of a display window of any one of the transmissive LCD light valves is parallel to a central intersection line of the X-cube;

when there are two transmissive LCD light valves which are defined to be a first transmissive LCD light valve and a second transmissive LCD light valve, light emitted by the first transmissive LCD light valve passes through the light combining device and the projection lens in sequence and then is projected out; light emitted by the second transmissive LCD light valve is reflected by the light combining device, and then overlaps with light transmitted by the first transmissive LCD light valve through the light combining device, and then is projected out through the projection lens; a reflective surface of the light combining device for reflecting the light emitted by the second transmissive LCD light valve intersects an optical axis of the projection lens and an intersection is formed; a straight line on the reflective surface passes through the intersection and is parallel to a long side of a display window of the first transmissive LCD light valve or the second transmissive LCD light valve; the light emitted by the second transmissive LCD light valve through the light combining device turns in a mirror manner along a plane determined by the straight line and the optical axis of the projection lens.

Also, the present invention provides a projector, which comprises the projection module mentioned above, wherein when there are three transmissive LCD light valves, the projector is a 3LCD projector; when there are two transmissive LCD light valves, the projector is a 2LCD projector.

The present invention has some beneficial effects as follows.

(1) The long side of the display window of the LCD light valve provided by the present invention is parallel to the central intersection line of the X-cube, so that the length and width of the X-cube are reduced as much as possible, which significantly improves the manufacturing difficulty of the X-cube and reduces the manufacturing cost thereof. Although the size in the height direction of the X-cube is increased, the increase in the height of the X-cube does not affect the manufacturing difficulty, and has a small impact on the cost within a certain size range.

(2) Whether the light combining device, of the 2LCD projector provided by the present invention, synthesizes light by a prism method or a flat plate method, it is significantly improved in the manufacturing difficulty, reduced in the manufacturing cost, increased in the light combining quality, so that the brightness and color unevenness of the projected images are improved, thereby increasing the user satisfaction with viewing experience.

(3) The present invention enables more novel options for the layout and shape of the whole machine, and has a new choice dimension for changing and innovating the unchanging appearance of the projector; at the same time, due to the reduction of the length and width of the X-cube or the reduction of the light combining device, the back focal length of the projection lens is correspondingly reduced, which significantly improves the manufacturing difficulty of the projection lens and reduces the manufacturing cost thereof.

### BRIEF DESCRIPTION OF THE DRAWINGS

In order to more clearly illustrate technical solutions of embodiments of the present invention or prior arts, the drawings used in the embodiments or prior arts will be briefly described as below. It should be understood that the following drawings show only certain embodiments of the present invention and are therefore not considered as limiting the protective scope of the present invention. For those skilled in the art, other relevant drawings are also able to be obtained according to these drawings without any creative work.

FIG. 1 is a three-dimensional schematic diagram of a projection module according to a first preferred embodiment of the present invention, wherein there are three transmissive LCD light valves.

FIG. 2 is a three-dimensional schematic diagram of a projection module according to a second preferred embodiment of the present invention, wherein there are two transmissive LCD light valves.

FIG. 3 is a partial top view of FIG. 1.

FIG. 4 is a left view of the projection module shown in FIG. 1.

FIG. 5 is a schematic view of a projection module of the prior art, wherein there are three transmissive LCD light valves.

FIG. 6 is a schematic view of an X-cube.

FIG. 7 is a partial top view of FIG. 5.

FIG. 8 is a left view of the projection module shown in FIG. 5.

FIG. 9 is a schematic view of a projection module of the prior art, wherein there are two transmissive LCD light valves.

FIG. 10 is another schematic view of a projection module of the prior art, wherein there are two transmissive LCD light valves.

### DETAILED DESCRIPTION OF THE PREFERRED EMBODIMENT

In order to enable those skilled in the art to better understand the technical solutions of the present invention, the present invention will be described in detail with reference to the accompanying drawings as follows. The description herein is only exemplary and explanatory, and should not have any limiting effect on the protection scope of the present invention.

It should be known that similar reference numerals and letters indicate similar items in the following drawings. Therefore, once a certain item is defined in one drawing, it does not need to be further defined and explained in the subsequent drawings.

It should be noted that the orientation or positional relationship indicated by the terms, such as “center”, “upper”, “lower”, “left”, “right”, “vertical”, “horizontal”, “inner” and “outer”, is based on the orientation or positional relationship shown in the drawings, or the orientation or positional relationship that the product provided by the present invention is usually placed in use, which is only for the convenience of describing the present invention and simplifying the description, rather than indicating or implying that the device or element referred to must have a specific orientation, be constructed and operated in a specific orientation. Therefore, these terms are unable to be understood as a limitation to the present invention. In addition, the terms such as “first”, “second” and “third” are only used for distinguishing description, and are unable to be understood as indicating or implying relative importance.

Moreover, the terms such as “horizontal”, “vertical” and “overhanging” do not mean that the component is required to be absolutely horizontal, vertical or overhanging, but may be slightly inclined. For example, “horizontal” only means that the direction of an element is more horizontal than “vertical”, it does not mean that the element must be completely horizontal, but is able to be slightly inclined.

In the description of the present invention, it should also be noted that the terms such as “set”, “installation”, “connection” and “communication” should be understood in a broad sense, unless otherwise clearly specified and limited. For example, “connection” may be fixed connection, detachable connection or integral connection; it also may be mechanical connection or electrical connection; it also may be direct connection, indirect connection through an intermediate medium, or the internal communication between two components. For those skilled in the art, the specific meanings of the above-mentioned terms in the present invention are understood according to specific situations.

### First Embodiment

Referring to FIGS. 1, 3 and 4, a projection module according to a first preferred embodiment of the present invention is illustrated, which comprises three transmissive liquid crystal display (LCD) light valves, a light combining device and a projection lens 1, wherein the light combining device is an X-cube 2, a long side W of a display window of any one of the transmissive LCD light valves is parallel to a central intersection line A of the X-cube 2; the three transmissive LCD light valves are a red field LCD light valve 3 for displaying red field images, a green field LCD light valve 4 for displaying green field images, and a blue field LCD light valve 5 for displaying blue field images, respectively; the green field LCD light valve 4 and the projection lens 1 are located at two opposite sides of the X-cube 2, respectively.

According to the first preferred embodiment of the present invention, the red field LCD light valve 3, the green field LCD light valve 4 and the blue field LCD light valve 5 are installed near three incident surfaces of the X-cube 2, the specific positions are determined by a back focal length and a position of the projection lens 1, a length, a width and a refractive index of the X-cube 2, and a refractive index of glass substrates of the three transmissive LCD light valves; the green field LCD light valve 4 and the projection lens 1 are located at the two opposite sides of the X-cube 2, respectively; the long side W of the display window of any one of the three transmissive LCD light valves is parallel to the central intersection line A of the X-cube 2, referring to symbol “II” in the drawings. As shown in FIG. 1, flexible printed circuit (FPC) cables 10 of the three transmissive LCD light valves are able to be drawn out from an area corresponding to the long side W of the display window of any one of the three transmissive LCD light valves, and also able to be drawn out from an area corresponding to a short side of the display window of any one of the three transmissive LCD light valves, which is determined by a driver integrated circuit (IC) of the three transmissive LCD light valves. For example, many ICs of Sitronix Technology Corporation support the extraction from the long side, while many ICs of Himax Technologies, INC. support the extraction from the short side.

Light with a certain aperture angle θ passes through the green field LCD light valve 4 (theoretically, an aperture angle of light passing through the red field LCD light valve 3 and the blue field LCD light valve 5, and the aperture angle θ of the light passing through the green field LCD light valve 4 are the same). When a distance between the green field LCD light valve 4 and an incident surface of the X-cube 2 is known, the length a and the width b of the display window of the green field LCD light valve 4 are known (also, a refractive index of a glass substrate of the green field LCD light valve 4, and a refractive index of the X-cube 2 are known at the time of design and production), a length or width k of the X-cube 2, and a height c of the X-cube 2 are determined, in which the length and width of the X-cube 2 are equal.

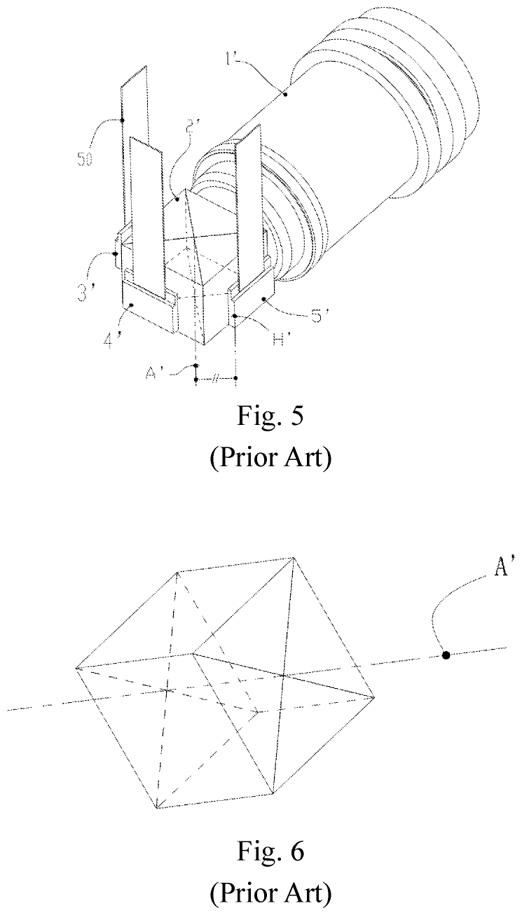

Similarly, referring to the prior art in FIGS. 5 to 8, a central intersection line A′ of an X-cube 2′ is parallel to a short side H′ of a display window of any one of the transmissive LCD light valves. Light with a certain aperture angle θ′ passes through a green field LCD light valve 4′, when a distance between the green field LCD light valve 4′ and an incident surface of the X-cube 2′ is known, a length a′ and a width b′ of the display window of the field LCD light valve are known, a length and width k′ of the X-cube 2′, and a height c′ thereof are determined.

Usually, the lengths a and a′ of the display window of any one of the LCD light valves are much larger than the widths b and b′ thereof, respectively. In general, a ratio of the length to the width is 16:9, 16:10 or 24:9. Comparing FIGS. 1, 3 and 4 with FIGS. 5 to 8, it is not difficult to see that if θ=θ′, a=a′, b=b′, the distance between any one of the LCD light valves and the incident surface of the X-cube 2′ is equal to the distance between any one of the LCD light valves and the incident surface of the X-cube 2′, then k<k′ and c>c′.

Therefore, if the prior art shown in FIGS. 5-8, the length and the width of the X-cube determined by the light valve with larger size based on low temperature poly-silicon (LTPS) technology are much larger than those determined by the light valve with smaller size based on high temperature poly-silicon (HTPS) technology, so that it is difficult and expensive to manufacture X-cubes suitable for domestic large-size LCD light valves, and even there is no actual commercial value at all. However, the present invention is able to effectively greatly reduce the length and width of the X-cube determined by the light valves with larger size based on LTPS technology till the manufacturing difficulty and manufacturing cost have actual value.

In addition, the larger the k or k′ is, the more difficult the X-cube is to be made, the higher the cost is, and the longer the back focal length of the projection lens is. The projector is not able to meet the needs of the user's installation site at any projection ratio. Therefore, when the focal length of the projection lens (which is the key parameter that determines the projection ratio) is fixed in principle, the longer the back focal length of the projection lens is, the more difficult the projection lens is to be made and the higher the cost is.

The condition c>c′ has a very small impact on the cost of the X-cube. Compared with the manufacturing difficulty and cost difference caused by different k′ and k, the increased cost of increasing the height c of the X-cube is able to be ignored.

Furthermore, according to the present invention, the long sides W of the three LCD light valves are parallel to the central intersection line A of the X-cube 2, and according to the prior art, the short sides H′ of the three LCD light valves are parallel to the central intersection line A′ of the X-cube 2′, so that the position and arrangement of the projection module which includes the three LCD light valves, the X-cube 2 and the projection lens 1, provided by the present invention are completely different from those provided by the prior art. Therefore, the present invention provides a new choice for the design of the projector.

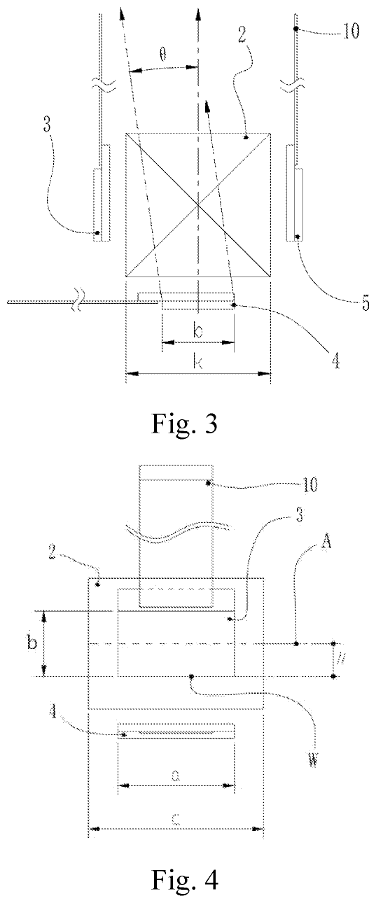

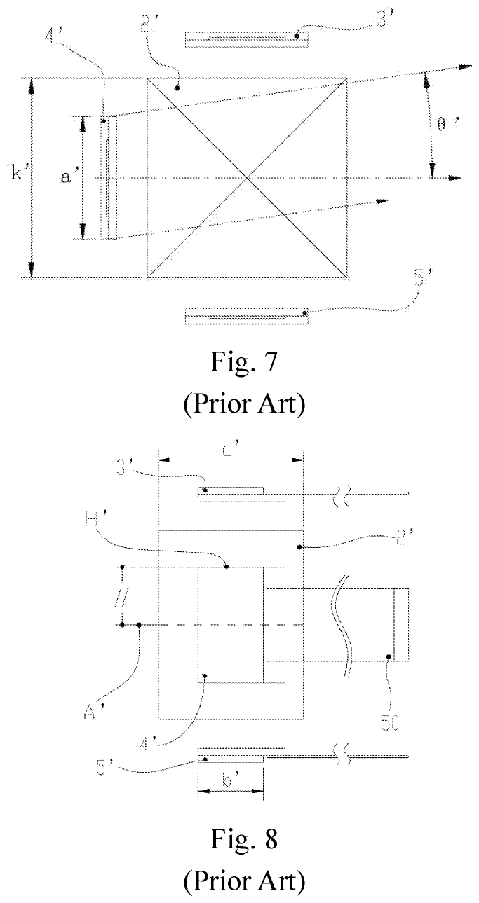

In fact, for any projector, the projection light source has a certain numerical aperture instead of an ideal “point light source”, so that for the light passing through the LCD light valve, the θ′ value shown in FIG. 7 is much larger than the θ value shown in FIG. 3 (because the length a is much larger than the width b of the display window of the LCD light valve). Accordingly, for the aforementioned 2-2.5 inches domestic LCD light valves, the traditional arrangement technology is used, the length and width K′ of the X-cube 2′ are too big. Under existing optical manufacturing processes, it is difficult to obtain mass production and low cost. However, with the arrangement method provided by the present invention, the projection light source with the same numerical aperture is used, because the θ value shown in FIG. 3 is much smaller than the θ′ value shown in FIG. 7, the length and width K of the X-cube 2 are effectively reduced, which also creates conditions that are conducive to processing.

### Second Embodiment

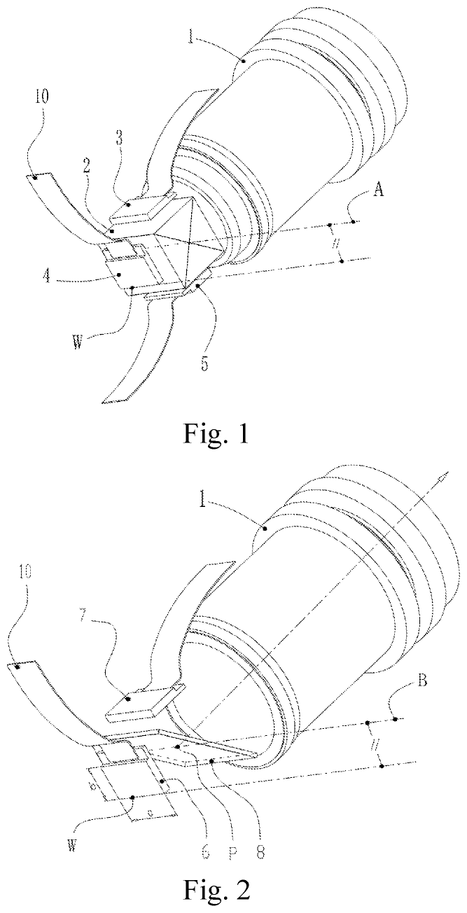

Referring to FIG. 2, a projection module according to a second preferred embodiment of the present invention is illustrated, which comprises a first transmissive liquid crystal display (LCD) light valve 6, a second transmissive LCD light valve 7, a light combining device 8 and a projection lens 1.

According to the second preferred embodiment of the present invention, light emitted by the first transmissive LCD light valve 6 passes through the light combining device 8 and the projection lens 1 in sequence, and then is projected out; light emitted by the second transmissive LCD light valve 7 is reflected by the light combining device 8, and then overlaps with light emitted by the first transmissive LCD light valve 6 through the light combining device 8, and then is projected out through the projection lens 1. An intersection, of a reflective surface of the light combining device 8 for reflecting the light emitted by the second transmissive LCD light valve 7 with an optical axis of the projection lens 1, is defined to be P. A straight line, which is on the reflective surface, passes through the intersection P and is parallel to the long side W of the display window of any one of the LCD light valves, is defined to be B. The light, emitted by the second transmissive LCD light valve 7 and then reflected by the light combining device 8, turns in a mirror manner along a plane determined by the straight line B and the optical axis of the projection lens 1.

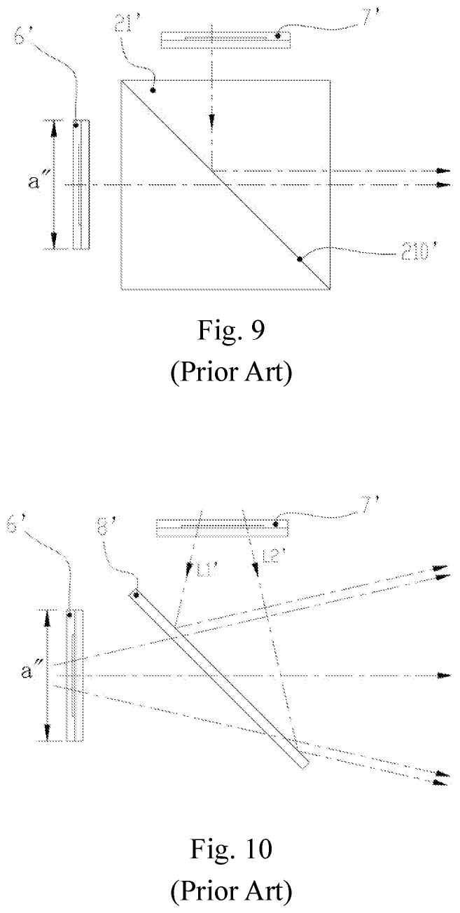

Whether the light combining device 8 in FIG. 2 synthesizes light by a prism method or a flat plate method, it has significantly differences in effect and structure compared with that in FIGS. 9 and 10.

Referring to FIG. 10, light L1′ with a first aperture angle and light L2′ with a second certain aperture angle pass through the LCD light valve 7′ and irradiate on the reflective surface of the flat light combining lens 8′; the incident angles of the light L1′ and the light L2′ to the reflective surface are different, the incident angle of the light L2′ is larger than that of the light L1′ (if an angle between the optical axis and the reflective angle is 45°, then the incident angle of the light L1′ to the reflective surface is equal to 45°−the first aperture angle, the incident angle of the light L2′ to the reflective surface is equal to 45°+the second aperture angle). As the above-mentioned aperture angles increase, the difference between the incident angles of the light L1′ and the light L2′ is multiplied. No matter what the reflective surface of the flat light combining lens 8′ is embodied as a reflective film (which splits light by wavelength or polarization method), the reflectivity is different because of different incident angles of light, and the color coordinates of the reflected light and the incident light are also different. Obviously, for the reflective surface of the flat light combining lens 8′, different incident angles and different wavelengths bring to different reflectivity. Therefore, for the imaging system of the projector shown in FIG. 10, it is very easy to make the left side and the right side of the projected image appear obvious differences in brightness and color, such as one side is yellowish, another side is bluish, while one side is higher in brightness and another is lower, which negatively affects the user's viewing experience. When the light emitted by the LCD light valve 6′ irradiates the incident surface and the exit surface of the flat light combining lens 8′ in sequence, because of different incident angles and different wavelengths, light transmittances are different, so that brightness and color unevenness are further deteriorated. FIG. 9 illustrates that light is synthesized by the prism method and has the same rule for the above-mentioned transmission and reflection characteristics.

For this engineering problem that different incident angles and different wavelengths cause the projector to produce brightness and color deficiencies, so far, there is no proper solution for the spectroscopic device that needs to have transmission and reflection functions. People try to solve the above problems by preparing “gradient dichroic film”. In optical systems with smaller aperture angles (such as ≤5°), the gradient dichroic film technology has certain practicability. The aperture angle of the light passing through the LCD light valve directly determines the output brightness of the projector within the allowable range of the projection lens, so an aperture angle of ≤5° is almost of no practical value. Generally, the Fno of the projection lens is in a range of 1.6 (corresponding to 18.2°) to 2.8 (corresponding to 10.3°).

As shown in FIGS. 1-3, as mentioned above, the length a and the width b of the display window of the LCD light valve have a very obvious value difference, and the width is much smaller than the length. Therefore, the light passing through the LCD light valve, the aforementioned θ′ is much larger than θ. It is able to be known from FIG. 2 that the long side W of the display window of the LCD light valve is parallel to the straight line B, and from FIGS. 9-10 that the short side of the display window of the LCD light valve is parallel to the straight line B. Due to the reduction of θ, the difference in the incident angle of light of the light combining device 8 is reduced, the brightness and color deficiencies of the projected image are much slighter.

Since only at the direction orthogonal to the aforementioned plane that produces the mirror turning (that is, the plane determined by the straight line B and the optical axis of the projection lens 1), the light combining device will produce different transmissivity and reflectivity due to different incident angles of light. At the direction parallel to the aforementioned plane that produces the mirror turning, no different incident angles of light exist (that is, there is no addition or subtraction of the aforementioned 45° to the aperture angle), so that there will be no different transmissivity and reflectivity. Therefore, the decrease or increase of θ of the light combining device has a very significant effect difference. For the production of the reflective film in a direction orthogonal to the plane that produces the mirror turning, even if θ is reduced by 1°, not only the performance but also the production cost is significantly improved.

At the same time, the effective reduction of the K value of the light combining device 8 in FIG. 3 has a similar rule, so the present invention is obviously helpful to reduce the back focal length of the projection lens.

### Third Embodiment

The present invention also provides a projector, which comprises the projection module described in the first embodiment and the second embodiment. When there are three LCD light valves, the projector is a 3LCD projector; when there are two LCD light valves, the projector is a 2LCD projector.

It should be noted that, in the present invention, the terms such as “include”, “comprises” or any other variants thereof are intended to cover non-exclusive inclusion, so that a process, method, article or device including a series of elements not only includes the series of elements, but includes other elements that are not explicitly listed, or includes inherent elements of the process, method, article, or device.

Specific embodiments are used in the present invention to illustrate the principle and implementation thereof. The description of the above embodiments is only used to help understand the method and core idea of the present invention. The above are only the preferred embodiments of the present invention. It should be pointed out that due to the limited expression of words, but objectively unlimited specific structures, for those skilled in the art, without departing from the principle of the present invention, several improvements, modifications or changes are also able to be made, or the above technical features are able to be combined in an appropriate manner. These improvements, modifications or combinations, or the concept and technical solution of the present invention which are directly applied to other occasions without improvement, should be regarded as the protection scope of the present invention.

What is claimed is:

1. A projection module, which comprises two or three transmissive liquid crystal display (LCD) light valves, a light combining device and a projection lens (1), wherein:
when there are three transmissive LCD light valves, the light combining device is an X-cube (2), a long side (W) of a display window of any one of the transmissive LCD light valves is parallel to a central intersection line (A) of the X-cube (2);
when there are two transmissive LCD light valves, which are a first LCD light valve (6) and a second LCD light valve (7), respectively, light emitted by the first LCD light valve (6) passes through the light combining device (8) and the projection lens (1) in sequence and then is projected out; light emitted by the second LCD light valve (7) is reflected by the light combining device (8) and overlaps with light transmitted by the first LCD light valve (6) through the light combining device (8), and then is projected out through the projection lens (1); an intersection of a reflective surface of the light combining device (8) for reflecting the light emitted by the second LCD light valve (7), with an optical axis of the projection lens (1) is defined to be P; a straight line, which is on the reflective surface, passes through the intersection P and is parallel to the long side W of the display window of any one of the transmissive LCD light valves, is defined to be B; the light, emitted by the second transmissive LCD light valve (7) and reflected by the light combining device (8), turns in a mirror manner along a plane determined by the straight line (B) and the optical axis of the projection lens (1).

2. A projector, which comprises the projection module according to claim 1.
